(19) United States
(12) Patent Application Publication
(10) Pub. No.: US 2025/0239590 A1
(43) Pub. Date: Jul. 24, 2025

(54) ELECTRODE LAYER AND BATTERY

(71) Applicant: TOYOTA JIDOSHA KABUSHIKI KAISHA, Toyota-shi (JP)

(72) Inventors: Kazushige NOMOTO, Sunto-gun (JP); Hideaki NISHIMURA, Sunto-gun (JP)

(73) Assignee: TOYOTA JIDOSHA KABUSHIKI KAISHA, Toyota-shi (JP)

(21) Appl. No.: 19/024,762

(22) Filed: Jan. 16, 2025

(30) Foreign Application Priority Data
Jan. 23, 2024 (JP) 2024-007970

(51) Int. Cl. H01M 4/134; H01M 4/02; H01M 4/38; H01M 4/62; H01M 10/0562

(52) U.S. Cl. CPC H01M 4/134; H01M 4/386; H01M 4/387; H01M 4/623; H01M 4/625; H01M 10/0562; H01M 2004/021; H01M 2004/028; H01M 2300/0068

(57) ABSTRACT

A main object of the present disclosure is to provide an electrode layer of which volume change amount is suppressed. The present disclosure achieves the object by providing an electrode layer including a composite particle, wherein the composite particle includes: a plurality of active material containing a Si element or a Sn element; and a binder; and when R designates an average particle size of the composite particle in a thickness direction of the electrode layer, and d designates a thickness of the electrode layer, a rate of the R with respect to the d, which is R/d, is 0.20 or less.

### TECHNICAL FIELD

The present disclosure relates to an electrode layer and a battery.

### BACKGROUND ART

In recent years, the development of a battery has been actively carried out. For example, the development of a battery used for battery electric vehicles (BEV), plug-in hybrid electric vehicles (PHEV), or hybrid electric vehicles (HEV) has been advanced in the automobile industry. Also, the development of members and materials to be used for the battery has been advanced.

For example, Patent Literature 1 discloses an anode layer containing a composite particle including a plurality of particles including a Si element or a Sn element, and a binder, wherein a void rate is 15% or less. Also, Patent Literature 2 discloses that, in a non-aqueous liquid electrolyte secondary battery, a thickness of an anode active material layer is twice or less of an average particle size of an anode particle.

### CITATION LIST

### Patent Literatures

Patent Literature 1: Japanese Patent Application Laid-Open (JP-A) No. 2019-121557
Patent Literature 2: JP-A No. 2004-146104

### SUMMARY OF DISCLOSURE

### Technical Problem

The theoretical capacities of Si and Sn are large and it is advantageous to allow a battery to have high energy density. On the other hand, the volume change amount during charge and discharge is large, and there is a risk that the volume change amount (expansion/contraction amount) of the electrode layer using Si or Sn may be large. When the volume change amount of the electrode layer is large, there is a risk that the ion conduction path may be cut out to increase the battery resistance. In this point, as in Patent Literature 1, suppressing the volume change amount of the electrode layer by arranging a void in the electrode layer has been considered, but there is room for further improvement for the volume change.

The present disclosure has been made in view of the above circumstances and a main object thereof is to provide an electrode layer of which volume change amount is suppressed.

### Solution to Problem

[1]

An electrode layer comprising a composite particle, wherein
the composite particle includes: a plurality of active material containing a Si element or a Sn element; and a binder; and
when R designates an average particle size of the composite particle in a thickness direction of the electrode layer, and d designates a thickness of the electrode layer, a rate of the R with respect to the d, which is R/d, is 0.20 or less.

[2]

The electrode layer according to [1], wherein the R/d is 0.03 or more.

[3]

The electrode layer according to [1] or [2], wherein the R is 1 μm or more and 16 μm or less.

[4]

The electrode layer according to any one of [1] to [3], wherein the d is 28 μm or more and 81 μm or less.

[5]

The electrode layer according to any one of [1] to [4], wherein the active material contains the Si element, and includes a void inside.

[6]

The electrode layer according to any one of [1] to [5], wherein the active material contains the Si element, and includes a silicon clathrate type crystal phase.

[7]

The electrode layer according to any one of [1] to [6], wherein the electrode layer contains a conductive aid and a solid electrolyte.

[8]

The electrode layer according to [7], wherein the solid electrolyte is a sulfide solid electrolyte.

[9]

A battery comprising a cathode active material layer, an anode active material layer, and an electrolyte layer arranged between the cathode active material layer and the anode active material layer, wherein
the anode active material layer is the electrode layer according to any one of [1] to [8].

[10]

The battery according to [9], wherein the electrolyte layer is a solid electrolyte layer.

### Advantageous Effects of Disclosure

The present disclosure exhibits an effect of suppressing the volume change amount of the electrode layer.

### BRIEF DESCRIPTION OF DRAWINGS

FIGS. 1A to 1D are diagrams explaining a method for calculating R/d in the present disclosure.

FIGS. 2A to 2C are diagrams explaining the crystal phases of the Si-based active material in the present disclosure.

FIG. 3 is a schematic cross-sectional view exemplifying the battery in the present disclosure.

FIG. 4 is a graph showing the results of Examples and Comparative Examples.

### DESCRIPTION OF EMBODIMENTS

The electrode layer and the battery in the present disclosure will be hereinafter explained in details.

### A. Electrode Layer

The electrode layer in the present disclosure contains a composite particle. The composite particle includes, a plurality of active material containing a Si element or a Sn element, and a binder. Also, when R designates an average particle size of the composite particle in a thickness direction of the electrode layer, and d designates a thickness of the electrode layer, a rate of the R with respect to the d, which is R/d, is 0.20 or less. Here, in the present specification, an active material containing a Si element may be referred to as a Si-based active material, and an active material containing a Sn element may be referred to as a Sn-based active material.

According to the present disclosure, the electrode layer contains the specified composite particle, and the R/d is 0.20 or less, and thus the volume change amount of the electrode layer is suppressed.

When the R/d increases, it is presumed that the average particle size R of the composite particle in the thickness direction increases. Also, when the R/d increases, it is presumed that the number of the composite particle to be arranged in the thickness direction of the electrode layer relatively decreases. As a result, in one composite particle, reaction with a carrier ion easily occurs on the surface of the electrolyte layer side, and reaction with the carrier ion does not easily occur on the surface of the current collector side. For this reason, in one composite particle, reaction with the carrier ion will be uneven, and the expansion and contraction amount of the composite particle due to the expansion and contraction of the active material increases.

In contrast, in the electrode layer in the present disclosure, the R/d is 0.20 or less, and thus the reaction unevenness in the composite particle can be suppressed, and also, since sufficient ion conduction path can be secured, it is presumed that the reaction unevenness in the electrode layer overall can be suppressed. As a result, it is presumed that the volume change amount of the electrode layer is suppressed.

The R/d may be 0.18 or less, may be 0.16 or less, and may be 0.14 or less. Meanwhile, the R/d is, for example, 0.02 or more, may be 0.03 or more, may be 0.05 or more, may be 0.08 or more, and may be 0.10 or more. Here, in general, the carrier ion moves inside the electrode layer by passing through an electrolyte part with good ion conductivity. In other words, the ion conduction path of the carrier ion bends to avoid the composite particle part. Also, when the R/d decreases, the number of the composite particle to be arranged in the thickness direction of the electrode layer relatively increases. As a result, the composite particle positioned in the electrolyte layer side easily reacts with the carrier ion, and the composite particle positioned in the current collector side does not easily react with the carrier ion. For this reason, reaction unevenness occurs in the electrode layer in the thickness direction, and there is a risk that the volume change amount as the electrode layer overall may increase. In contrast, when the R/d is 0.02 or more, bending degree of the ion conduction path can be sufficiently decreased, and the reaction unevenness can be sufficiently suppressed.

The average particle size R of the composite particle is not particularly limited if the R/d is satisfied. The R is, for example, 1 μm or more, may be 3 μm or more, and may be 5 μm or more. Meanwhile, the R is, for example, 16 μm or less, may be 15 μm or less, may be 10 μm or less, and may be 6 μm or less.

The thickness d of the electrode layer is not particularly limited if the R/d is satisfied. The d is, for example, 20 μm or more, may be 28 μm or more, may be 30 μm or more, and may be 50 μm or more. Meanwhile, the d is, for example, 100 μm or less, may be 90 μm or less, and may be 81 μm or less.

Here, the method for calculating the R/d will be explained. First, the thickness d of the electrode layer can be obtained by a conventionally known method. Examples thereof may include a method using an arbitrary thickness meter, and a method in which a cross-sectional image of the electrode layer obtained by a microscopic observation is analyzed.

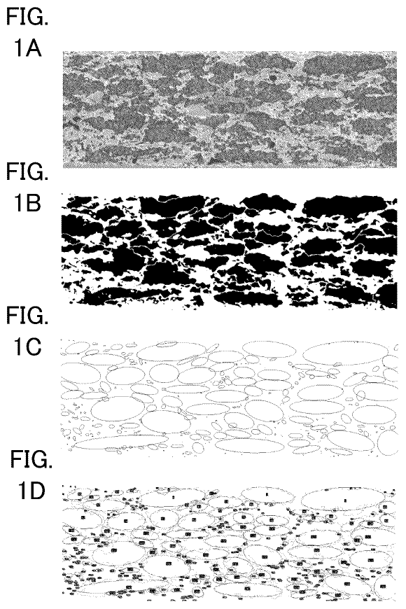

Also, the average particle size R of the composite particle can be obtained by, for example, a method as below. First, as shown in FIG. 1A, a cross-sectional image of the electrode layer is obtained by a scanning electron microscope (SEM). Next, as shown in FIG. 1B, an image analysis is performed to the cross-sectional image, and binarized into the composite particle portion (black) and a portion other than the composite particle (white). Incidentally, the composite particle portion and the other portion can be distinguished by, for example, an elemental analysis such as SEM-EDX. Next, as shown in FIG. 1C, in the binarized image, the composite particle portion is approximated to an oval by an image analyzing software. Then, as shown in FIG. 1D, the cross-sectional area with respect to each composite particle approximated to the oval is measured, and 50 pieces of the composite particle from the one with the largest cross-sectional area are selected. Then, the average value of the lengths in the thickness direction of the selected composite particles is obtained as the average particle size R of the composite particle.

The number of the composite particle to be selected may be more than 50 pieces. The number of the composite particle to be selected may be 100 pieces or more. Also, the observation field of the SEM image is preferably the field including the composite particles with the numbers described above or more. The observation field of the SEM image is, for example, 1000 μm² or more and 50000 μm² or less. Also, as the image analyzing software, for example, ImageJ Fiji can be used.

The R/d is calculated from the d and the R measured and calculated as described above.

### 1. Composite Particle

The composite particle in the present disclosure includes, a plurality of active material containing a Si element or a Sn element, and a binder. Incidentally, the composite particle can be taken as an aggregate in which a plurality of the active material (Si-based active material or Sn-based active material) are aggregated. Incidentally, the active material may be a primary particle, and may be a secondary particle which is aggregation of the primary particles.

The average particle size r (D₅₀) of the Si-based active material and the Sn-based active material is not particularly limited, and for example, it is 0.1 μm or more and 3 μm or less. The average particle size (D₅₀) refers to a volume accumulation particle size measured by a laser diffraction scattering particle distribution measurement device. The number of the active material included in the composite particle is, for example, 10 pieces or more and 150 pieces or less.

An active material containing a Si element (Si-based active material) may be a simple substance of Si, may be an alloy containing Si as a main component (Si alloy), and may be a Si oxide. The proportion of the Si element in the Si alloy is, for example, 50 mol % or more and 95 mol % or less.

Also, the Si-based active material may include a void inside. Incidentally, the Si-based active material including void is called a porous Si. Presence of the void can be confirmed by a SEM (scanning electron microscope) observation. Also, the void rate is not particularly limited, but for example, it is 4% or more and may be 10% or more. Also, the void rate is, for example, 40% or less and may be 20% or less. The void rate can be obtained by, for example, in the following procedures. First, a cross-sectional image of the Si-based active material is obtained by SEM. From the obtained image, a silicon portion and the void portion are distinguished using an image analyzing software, and binarized. The areas of the silicon portion and the void portion are obtained, and the void rate (%) is calculated from the below equation:

$$Void rate ( \% ) = 100 * ( Area of void portion ) \text{} / ( ( Area of silicon portion ) + ( Area of void portion ) ) .$$

In the porous Si, a void amount of a void with a pore diameter of 50 nm or less is, for example, 0.05 cc/g or more and 0.30 cc/g or less. Also, the BET specific surface area of the porous Si is, for example, 20 m²/g or more and 200 m²/g or less.

Examples of the method for producing the porous Si may include a method in which an alloy of Li with Si (LiSi alloy) is produced and then Li is removed from the LiSi alloy. The LiSi alloy may be obtained by, for example, mixing Li and Si. Examples of the method for removing Li from the LiSi alloy may include a method in which the LiSi alloy is brought into reacting with Li extracting agent. Examples of the Li extracting agent may include alcohol such as methanol and acid such as acetic acid.

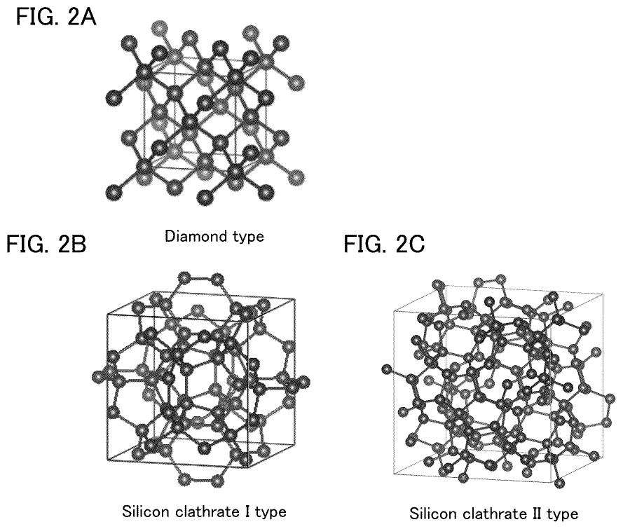

Here, FIGS. 2A to 2C are schematic perspective views explaining the crystal phases of Si. In general, Si includes a diamond type crystal phase as shown in FIG. 2A. In contrast, the Si-based active material in the present disclosure may include a silicon clathrate type crystal phases as shown in FIGS. 2B and 2C. In the diamond type crystal phase shown in FIG. 2A, a plurality of Si elements form a tetrahedron. The tetrahedron does not have a space inside to include metal ions such as Li ions. Meanwhile, in the silicon clathrate I type and II type crystal phases shown in FIGS. 2B and 2C, a backbone atom includes a basket type structure (cage), and metal ions such as Li ions can enter there, and thus the expansion and contraction of the composite particle can be further suppressed. As a result, the expansion and contraction of the electrode layer can be further suppressed. Incidentally, the Si-based active material including the silicon clathrate type crystal phase is referred to as a clathrate Si, and in particular, the Si-based active material including the void as well as the clathrate type crystal phase is referred to as a porous clathrate Si (pc-Si).

The Si-based active material may include a silicon clathrate I type crystal phase, and may include a silicon clathrate II type crystal phase. In particular, the Si-based active material preferably includes the silicon clathrate II type crystal phase as a main phase. “Main phase” means that the peak belonging to that crystal phase has the largest diffraction intensity among the peaks observed in an X-ray diffraction measurement. The proportion of the silicon clathrate II type crystal phase included in the Si-based active material is, for example, 80 weight % or more, may be 85 weight % or more, may be 90 weight % or more, and may be 95 weight % or more. Also, the proportion of the silicon clathrate II type crystal phase included in the Si-based active material may be 100 weight %, and may be less than 100 weight %. The proportion of the crystal phase can be obtained by using a RIR method (Reference Intensity Ratio method).

Examples of the method for producing the porous clathrate Si may include a method in which the porous Si and a Na source such as NaH are mixed and heated to produce a Na—Si alloy, and the Na amount in the Na—Si alloy is reduced by heating the Na—Si alloy to generate the silicon clathrate type crystal phase.

The active material containing a Sn element (Sn-based active material) may be a simple substance of Sn, may be an alloy containing Sn as a main component (Sn alloy), and may be a Sn oxide. The proportion of the Sn element in the Sn alloy is, for example, 50 mol % or more and 95 mol % or less.

The proportion of the Si-based active material or the Sn-based active material in the composite particle is, for example, 90 weight % or more and 99 weight % or less.

There are no particular limitations on the binder in the present disclosure. Examples of the binder may include a polyimide-based binder; a rubber-based binder such as an amine modified butadiene rubber (ABR), a butadiene rubber (BR), and a styrene butadiene rubber (SBR); a cellulose-based binder such as carboxy methyl cellulose (CMC); an acryl-based binder such as polyacrylic acid, polyacrylate, and polyacrylic ester; and a fluoride-based binder such as polyvinylidene fluoride (PVDF) and polytetra fluoroethylene (PTFE). The binder may be used in just one kind, and may be used by mixing a plural kinds.

The proportion of the binder in the composite particle is, for example, 0.5 weight % or more, and may be 10 weight % or less.

Here, in the electrode layer, the aspect ratio of the composite particle is, for example, 3.6 or less, may be 3.5 or less, may be 3.3 or less, may be 3.0 or less, and may be 2.8 or less. Meanwhile, the aspect ratio is, for example, 1.5 or more, may be 1.6 or more, and may be 1.8 or more, may be 2.0 or more, may be 2.3 or more, and may be 2.5 or more. Incidentally, the aspect ratio of the composite particle refers to a rate (b/a), which is the rate of a long diameter b with respect to a short diameter a of the composite particle, obtained when the cross-sectional shape of the composite particle in the electrode layer is approximated to an oval. Also, it is presumed that the electrode layer is produced by applying a pressing pressure. In other words, it is presumed that the composite particle is included in the electrode layer in a state compressed in the thickness direction of the electrode layer. For this reason, the short diameter a of the composite particle can be taken as a length of the composite particle in the thickness direction of the electrode layer (up and down direction of the paper in FIGS. 1A to 1D). Also, the long diameter b of the composite particle can be taken as a length of the composite particle in a direction crossing the thickness direction of the electrode layer (left and right direction of the paper in FIGS. 1A to 1D).

Here, the aspect ratio can be obtained by the cross-sectional SEM image of the electrode layer similarly to the above described R/d. As shown in FIGS. 1A to 1C, in the binarized SEM images, the composite particle portion is approximated to an oval by an image analyzing software. Then, regarding each composite particles approximated to ovals, short diameters, long diameters, and areas are measured to select 10 pieces of the composite particles from the one having the largest cross-sectional area. The aspect ratios (long diameter/short diameter) of each of the selected composite particles are measured from the short diameters and the long diameters, and the average value of the aspect ratios measured is obtained as the aspect ratio in the present disclosure. Incidentally, the number of the composite particles to be selected may be more than 10 pieces.

The proportion of the composite particle in the electrode layer is, for example, 50 weight % or more, may be 70 weight % or more, and may be 90 weight % or more. Meanwhile, the proportion of the composite particle is, for example, 99 weight % or less, and may be 95 weight % or less.

The composite particle may be produced in the following manner, for example. First, a slurry containing the above described Si-based active material or Sn-based active material, and a binder is prepared. Then, the slurry is sprayed in a hot air and dried by a spraying drying method. Thereby, the composite particle can be obtained. Here, the R in the composite particle can be adjusted by, for example, changing the solid content rate of the slurry and the conditions in the spraying drying method such as a spraying pressure. The solid content rate of the slurry is, for example, 0.5 weight % or more and 35 weight % or less. Also, the spraying pressure is, for example, 0.03 MPa or more and 0.20 MPa or less.

### 2. Electrode Layer

The electrode layer may be a cathode active material layer containing the composite particle as a cathode active material, and may be an anode active material layer containing the composite particle as an anode active material, but the latter is preferable. The reason therefor is to obtain a battery with high voltage. Also, the electrode layer may further contain at least one of a conductive aid, a binder, and an electrolyte, as required.

Examples of the conductive aid may include a carbon material. Examples of the carbon material may include a particulate carbon material such as acetylene black (AB) and Ketjen black (KB); and a fiber carbon material such as carbon fiber, carbon nanotube (CNT) and carbon nanofiber (CNF). The proportion of the conductive aid in the electrode layer is, for example, 0.01 weight % or more and 10 weight % or less, and may be 0.1 weight % or more and 5 weight % or less.

Examples of the binder may include the binders described in “1. Composite particle”. The binder in the composite particle and the binder in the electrode layer may be the same kind, and may be different kinds. The proportion of the binder in the electrode layer is, for example, 0.5 weight % or more and 10 weight % or less, and may be 1 weight % or more and 5 weight % or less.

The electrode layer preferably contains a solid electrolyte as an electrolyte. Examples of the solid electrolyte may include an inorganic solid electrolyte such as a sulfide solid electrolyte, an oxide solid electrolyte, and a halide solid electrolyte. The sulfide solid electrolyte preferably contains sulfur (S) as a main component of the anion element. The oxide solid electrolyte preferably contains oxygen (O) as a main component of the anion element. The halide solid electrolyte preferably contains halogen as a main component of the anion. Among these, a sulfide solid electrolyte is preferable.

It is preferable that the sulfide solid electrolyte contains a Li element, an M element (M is at least one kind of P, Sn, Al, Zn, In, Ge, Si, Sb, Ga and Bi), and a S element. Also, the sulfide solid electrolyte may contain a halogen element such as F, Cl, Br, and I. Also, in the sulfide solid electrolyte, a part of the S element may be substituted with an O element.

The sulfide solid electrolyte may be a glass-based (amorphous) sulfide solid electrolyte, may be a glass ceramic-based sulfide solid electrolyte, and may be a crystal-based sulfide solid electrolyte. Examples of the crystal phase included in the sulfide solid electrolyte may include a LGPS type crystal phase, a Thio-LISICON type crystal phase, and an argyrodite type crystal phase.

Examples of the sulfide solid electrolyte may include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m, n is a positive number; Z is any one of Ge, Zn, and Ga), Li₂S—GeS₂, Li₂S—SiS₂—Li₃PO₄, and Li₂S—SiS₂—LiₓMO_{y} (provided that x, y is a positive number; M is any one of P, Si, Ge, B, Al, Ga, and In).

The proportion of the solid electrolyte in the electrode layer is, for example, 30 weight % or more and 80 weight % or less, and may be 40 weight % or more and 70 weight % or less.

### B. Battery

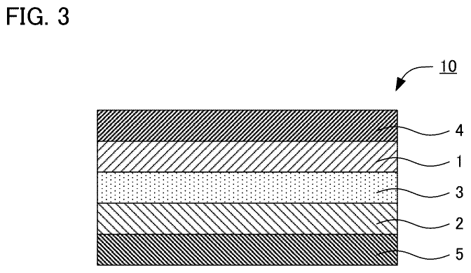

FIG. 3 is a schematic cross-sectional view exemplifying the battery in the present disclosure. Battery 10 shown in FIG. 3 includes cathode active material layer 1, anode active material layer 2, and electrolyte layer 3 arranged between the cathode active material layer 1 and the anode active material layer 2. Also, the anode active material layer 2 in the battery 10 is the above described electrode layer in the present disclosure.

### 1. Cathode Active Material Layer

The cathode active material layer contains at least a cathode active material, and contains at least one of a conductive aid, a binder, and an electrolyte, as required. The conductive aid, the binder and the electrolyte are in the same contents as those described in “A. Electrode layer”.

The cathode active material is not particularly limited if it is an active material having higher reaction potential than that of the composite particle. Examples of the cathode active material may include an oxide active material. Examples of the oxide active material may include a rock salt bed type active material such as LiCoO₂, LiNi_{0.8}Co_{0.15}Mn_{0.05}O₂ and LiNi_{0.33}Co_{0.33}Mn_{0.33}O₂, a spinel type active material such as LiMn₂O₄ and Li₄Ti₅O₁₂, and an olivine type active material such as LiFePO₄. Examples of the shape of the cathode active material may include a granular shape. The average particle size (D₅₀) of the cathode active material is, for example, 0.5 μm or more and 50 μm or less. The average particle size (D₅₀) is as described above.

The thickness of the cathode active material layer is not particularly limited, but for example, it is 0.1 μm or more and 1000 μm or less.

### 2. Anode Active Material Layer

The anode active material layer is the above described electrode layer. The electrode layer is in the same contents as those described in “A. Electrode layer”.

### 3. Electrolyte Layer

The electrolyte layer contains an electrolyte. The electrolyte is preferably a solid electrolyte. The solid electrolyte is in the same contents as those described in “A. Electrode layer” above. Also, the electrolyte layer may contain a binder as required. The binder is in the same contents as those described in “A. Electrode layer”. Incidentally, in the present disclosure, the electrolyte layer containing a solid electrolyte is called a solid electrolyte layer, and a battery including the solid electrolyte layer is called an all solid state battery.

The thickness of the electrolyte layer is not particularly limited, but for example, it is 0.1 μm or more and 1000 μm or less.

### 4. Other Constitutions

As shown in FIG. 3, battery 10 in the present disclosure usually includes cathode current collector 4 for collecting electrons of the cathode active material layer 1, and anode current collector 5 for collecting electrons of the anode active material layer 2. Examples of the material for the cathode current collector may include SUS, aluminum, nickel, iron, titanium, and carbon. Examples of the material for the anode current collector may include SUS, copper, nickel, and carbon.

Also, the battery in the present disclosure may include an outer package for storing the above described members. Examples of the outer package may include a laminate type outer package and a case type outer package. Also, the battery in the present disclosure may include a restraining jig that applies a restraining pressure of a thickness direction to the above described members. As the restraining jig, known jigs may be used. The restraining pressure is, for example, 0.1 MPa or more and 50 MPa or less, and may be 1 MPa or more and 20 MPa or less.

### 5. Battery

The battery in the present disclosure is typically a lithium ion secondary battery. Also, the battery in the present disclosure is preferably an all solid state battery including a solid electrolyte layer as an electrolyte layer. Examples of the applications of the battery may include a power source for vehicles such as hybrid electric vehicles (HEV), plug-in hybrid electric vehicles (PHEV), battery electric vehicles (BEV), gasoline-fueled automobiles and diesel powered automobiles. Also, the battery in the present disclosure may be used as a power source for moving bodies other than vehicles (such as rail road transportation, vessel and airplane), and may be used as a power source for electronic products such as information processing equipment.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

### <Production of Cathode>

A binder (PVDF), a conductive aid, a sulfide solid electrolyte, and a cathode active material (NCM: LiNi_{0.8}Co_{0.15}Mn_{0.05}O₂) were added to an organic solvent. After adding, the product was kneaded using an ultrasonic homogenizer to obtain a cathode slurry. The cathode slurry was applied on a cathode current collector (Al foil) and dried. Thereby, a cathode including a cathode current collector and a cathode active material layer was obtained.

### <Production of Anode>

A Si-based active material (pc-Si: average particle size (D₅₀) 0.5 μm) was projected into a binder solution containing an organic solvent and a binder (PVDF), and mixed to obtain an active material slurry. A composite particle containing a Si-based active material and a binder was produced by a spraying drying method using the active material slurry.

The composite particle, a binder (PVDF), a conductive aid (VGCF) and a sulfide solid electrolyte (Li₂S—P₂S₅-based sulfide solid electrolyte) were added to an organic solvent, and kneaded using an ultrasonic homogenizer. Thereby, an anode slurry was produced. The anode slurry was applied on an anode current collector (Cu foil) so that the thickness d of the electrode layer became the value shown in Table 1, and dried. Thereby, an anode including an anode current collector and an anode active material layer was obtained.

### <Production of Evaluation Battery>

A binder (PVDF), and a sulfide solid electrolyte (Li₂S—P₂S₅-based sulfide solid electrolyte) were added to an organic solvent, and kneaded using an ultrasonic homogenizer. Thereby, a mixture slurry was obtained. The mixture slurry was applied on a substrate (Al foil) and dried. Thereby, a transfer member including the substrate and the solid electrolyte layer was obtained.

The produced cathode, anode, and transfer member were respectively formed into a strip shape. Next, the cathode and the transfer member were overlapped so that the cathode active material layer and the solid electrolyte layer faced to each other, and roll-pressed at 165° C. and a pressure of 50 kN/cm. After that, the substrate was peeled off, and thereby a cathode side member was obtained. Also, the anode and the transfer member were overlapped so that the anode active material layer and the solid electrolyte layer faced to each other, and roll-pressed at 25° C. and a pressure of 50 kN/cm. After that, the substrate was peeled off, and thereby an anode side member was obtained. Next, the anode side member was punched out into φ13.00 mm, and the cathode side member was punched out into φ11.28 mm. Powder sulfide solid electrolyte was arranged on the solid electrolyte layer of the punched out anode side member, and uniaxially pressed. Next, the anode side member and the cathode side member were overlapped so that the solid electrolyte layers faced to each other, and tabs for taking out currents were installed to the cathode and the anode. Then, the product was sealed in an aluminum laminate using a vacuum lami-sealer, and restrained at a pressure of 5 MPa. Thereby, an evaluation battery (all solid state battery) was produced.

A SEM observation was performed to the produced evaluation battery, and a cross-sectional SEM image of the anode active material layer was obtained. By the above described method, the average particle size R of the composite particle and the thickness d of the electrode layer were obtained from the cross-sectional SEM image of the anode active material layer, and the R/d was calculated. The results are shown in Table 1.

### Examples 2 to 13 and Comparative Examples 1 to 5

A composite particle was respectively produced by changing the solid content rate of the slurry, and changing the spraying pressure in the spraying drying method. With the composite particle, an evaluation battery including an anode with the R/d shown in Table 1 was respectively produced by changing the application amount of the anode slurry.

### Evaluation

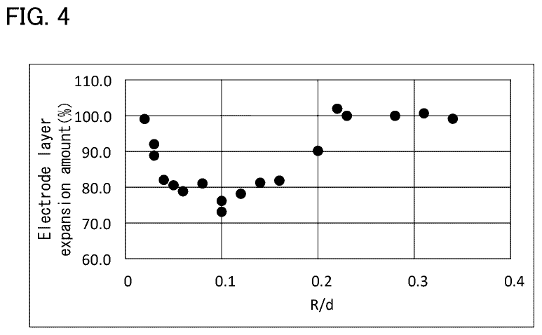

Each of the evaluation batteries produced was charged, and a restraining pressure increase amount measured by a load cell was evaluated as the electrode layer expansion amount. The results are shown in Table 1 and FIG. 4. Incidentally, the restraining pressure increase amount (electrode layer expansion amount) of Comparative Example 1 was regarded as 100%, and the evaluation was relatively performed.

TABLE 1

| | | | | Electrode layer |
|---|---|---|---|---|
| | | R | d | expansion amount |
| | R/d | (μm) | (μm) | (%) |
| Comp. Ex. 1 | 0.28 | 22.1 | 79.8 | 100.0 |
| Example 1 | 0.02 | 1.2 | 75.6 | 99.1 |
| Example 2 | 0.03 | 2.3 | 77.8 | 88.9 |
| Example 3 | 0.03 | 1.3 | 50.2 | 92.1 |
| Example 4 | 0.04 | 1.2 | 29.5 | 82.1 |
| Example 5 | 0.05 | 2.6 | 47.6 | 80.6 |
| Example 6 | 0.06 | 5.0 | 78.6 | 78.9 |
| Example 7 | 0.08 | 2.3 | 28.8 | 81.1 |
| Example 8 | 0.10 | 7.8 | 79.8 | 73.2 |
| Example 9 | 0.10 | 4.8 | 48.1 | 76.2 |
| Example 10 | 0.12 | 9.9 | 80.3 | 78.2 |
| Example 11 | 0.14 | 7.4 | 52.2 | 81.3 |
| Example 12 | 0.16 | 5.0 | 31.7 | 81.9 |
| Example 13 | 0.20 | 10.2 | 49.8 | 90.2 |
| Comp. Ex. 2 | 0.22 | 17.6 | 80.2 | 102.0 |
| Comp. Ex. 3 | 0.23 | 7.6 | 32.3 | 100.0 |
| Comp. Ex. 4 | 0.31 | 9.4 | 30.4 | 100.7 |
| Comp. Ex. 5 | 0.34 | 17.4 | 50.6 | 99.2 |

As shown in Table 1 and FIG. 4, the electrode layer expansion amount was suppressed in all Examples compared to Comparative Examples. In particular, the electrode layer expansion amount was remarkably suppressed when the R/d was in the range of 0.03 or more and 0.20 or less.

### REFERENCE SINGS LIST

1 cathode active material layer
2 anode active material layer
3 electrolyte layer
4 cathode current collector
5 anode current collector
10 battery

What is claimed is:

1. An electrode layer comprising a composite particle, wherein
the composite particle includes: a plurality of active material containing a Si element or a Sn element; and a binder; and
when R designates an average particle size of the composite particle in a thickness direction of the electrode layer, and d designates a thickness of the electrode layer, a rate of the R with respect to the d, which is R/d, is 0.20 or less.

2. The electrode layer according to claim 1, wherein the R/d is 0.03 or more.

3. The electrode layer according to claim 1, wherein the R is 1 μm or more and 16 μm or less.

4. The electrode layer according to claim 1, wherein the d is 28 μm or more and 81 μm or less.

5. The electrode layer according to claim 1, wherein the active material contains the Si element, and includes a void inside.

6. The electrode layer according to claim 1, wherein the active material contains the Si element, and includes a silicon clathrate type crystal phase.

7. The electrode layer according to claim 1, wherein the electrode layer contains a conductive aid and a solid electrolyte.

8. The electrode layer according to claim 7, wherein the solid electrolyte is a sulfide solid electrolyte.

9. A battery comprising a cathode active material layer, an anode active material layer, and an electrolyte layer arranged between the cathode active material layer and the anode active material layer, wherein
the anode active material layer is the electrode layer according to claim 1.

10. The battery according to claim 9, wherein the electrolyte layer is a solid electrolyte layer.
